(19) United States
(12) Patent Application Publication
(10) Pub. No.: US 2022/0024068 A1
(43) Pub. Date: Jan. 27, 2022

(54) 3D PRINTING METHOD USING SLIP

(71) Applicant: VOXELJET AG, Friedberg (DE)

(72) Inventors: Ingo Ederer, Geltendorf (DE); Daniel Günther, Munchen (DE)

(21) Appl. No.: 17/493,078

(22) Filed: Oct. 4, 2021

Related U.S. Application Data
(63) Continuation of application No. 15/039,211, filed on May 25, 2016.

(30) Foreign Application Priority Data
Nov. 27, 2013 (DE) 10 2013 019 716.3

(51) Int. Cl. B28B 1/00; B29C 64/165; B33Y 10/00; B28B 7/46; B33Y 30/00

(52) U.S. Cl. CPC B28B 1/001; B29C 64/165; B33Y 30/00; B28B 7/465; B33Y 10/00

(57) ABSTRACT

The invention relates to a 3D printing method, a device and molded parts produced with the aid of this method.

### FIELD OF THE INVENTION

The invention relates to a method for producing three-dimensional models by means of sinterable material as well as a device for carrying out this method and thus produced molded parts.

Methods for producing three-dimensional molded bodies (molded parts, models, components) are known from the prior art. Methods of this type are also referred to as “rapid prototyping” or “3D printing.”

Methods of this type are, for example, selective laser sintering (SLS), stereolithography, solid ground curing (SGC), fused deposition molding (FDM) or 3D binder printing.

In all methods, a molded body is built layer by layer on a build plane or in a build space, based on CAD data.

Special embodiments of the aforementioned methods are found, e.g., in WO2012/164078. A method for producing a metallic or ceramic molded body is described herein, in which a suspension made of a metallic or ceramic material is used. This publication does not disclose or suggest the method according to the invention.

EP 1 648 686 B1 describes a method for selectively sintering particulate material, using a radiation-absorbing material. This publication does not disclose or suggest the method according to the invention.

The known prior-art methods have various problems and disadvantages.

For example, a volume shrinkage occurs when sintering loose particulate feedstocks in layers, which is all the greater the lower the density of the particulate feedstock. In the methods known from the prior art for applying particulate materials in a thin layer to a build space, typical densities of less than 60% are achieved, in relation to the bulk material. I.e., if a dense component is to be produced, the volume shrinkage is more than 40%, and thus the linear shrinkage is even more than 16%. A shrinkage of this type, especially if it occurs layer by layer, may result in a distortion in the desired molded part, since lower layers may already have fully shrunk, and resulting forces act upon the already solidified structures. Without supporting structures, the solidified particle areas in the unsintered particulate material may move freely and deform. If the distortion is great enough that parts of the sintered surface project out of the build space, the coating device may carry along the sintered areas when another layer is applied, and an orderly buildup of the molded part can no longer occur. In addition, inaccuracies in the reproduction, compared to the CAD data, may occur in the components, since displacements may arise in the individual particle layers during application or when traversing the build plane. A high packing density in the produced molded bodies is also desirable, which may not always be ensured in known methods.

One object of the present invention was therefore to provide a method, by means of which high-quality and accurate molded bodies may be produced, by means of which a high particle packing in a molded body is facilitated and thus a very accurate reproduction of the CAD data may be achieved, or at least the disadvantages of the prior-art methods may be reduced or avoided.

### SUMMARY OF THE INVENTION

In one aspect, the invention relates to a method for producing molded bodies, a particle slip (particle dispersion, slip, dispersion) being applied in layers onto a build plane, which is preferably designed as a building platform, using a suitable device, preferably at a predetermined temperature, for the purpose of building a material layer and selectively applying a binder material, which includes an energy-absorbing material, and energy is applied for the purpose of selective solidification.

In another aspect, the invention relates to a device for carrying out the method.

In yet another aspect, the invention relates to molded parts produced with the aid of the method.

### DETAILED DESCRIPTION OF THE INVENTION

The invention is described in greater detail below, individual terms being explained in greater detail below.

“Sinterable material” within the meaning of the invention is any material or material mixture (201, 202), which is present in particulate form and may be solidified by applying energy. In a first method step, a powder cake may first be produced. Examples of a “sinterable material” are fine-grained, ceramic, metallic or plastic-based materials. These materials are known to those skilled in the art of 3D printing and therefore do not have to be described in detail here. Polyam ides, which are preferably used in the form of very fine powder, are particularly suitable in the invention.

“Slip” or “material dispersion” within the meaning of the invention comprises a carrier fluid and particulate material (e.g. sinterable material (201 or 202)), it being possible to individually set the ratio between the particulate material and the carrier fluid depending on the materials and the machine requirements. The particle size, the material properties of the particulate materials, the carrier fluid used and the type of application means have an influence on the mixing ratio. The particulate material contained in the “slip” may be a single material or a mixture of different materials. It preferably contains or comprises an at least partially meltable material. It is preferably a metal, a ceramic, a thermoplastic, a plastic, such as PMMA, which is preferably very fine-grained, or a glass powder or a mixture of multiple of the aforementioned materials, such as glass powder mixed with a polymer, such as PMMA. Material mixtures are used when a solidified molded part (green body, molded part) is to be produced in a first step, which is subjected to a further treatment in another work step and preferably in another device, preferably high temperatures, for the purpose of, for example, sintering the ceramic proportion or the metal proportion in the green body. The “slip” is preferably stirred in a suitable device prior to application or subjected to vibrations, so that it is present in the form of an essentially uniform dispersion during application. The material layer is produced by the fact that the carrier fluid at least partially runs off and/or evaporates.

The “carrier fluid” (200) within the meaning of the invention is any liquid which may be combined with the particular particulate material and which is able to disperse the particulate material without dissolving it. The “carrier fluid” is preferably water or an organic solvent, preferably an alcohol.

“Material layer” within the meaning of the invention is the layer which is applied in layers to, for example the build plane (preferably the building platform) or the immediately preceding material layer with the aid of an application means (also referred to as the recoater), and which is produced after the removal or evaporation of part or the essential part of the carrier fluid and is subsequently selectively solidified for the purpose of yielding the molded body to be produced. The layer thickness of the material layer is set individually using suitable means. The layer thickness of the applied particle layer may be 1 to 500 μm, preferably 100 μm, or 200 μm.

“Binder material” within the meaning of the invention is a material which is applied selectively to each particle layer and which includes or comprises an energy-absorbing or radiation-absorbing material. According to the invention, the “binder material” may be applied after each particle application or at regular or irregular intervals, for example after each second, third, fourth, fifth or sixth particle layer application. The “binder material” is dosed in a suitable and advantageous quantity for the method, using suitable means, such as a print head (100) or other suitable application means, according to the current cross-section of the desired molded body. In interaction with the heat or energy source, suitable energy-absorbing or radiation-absorbing material is used, which also has corresponding properties with respect to the particulate material used.

“Energy-absorbing material” within the meaning of the invention, or “radiation-absorbing material,” is any material which absorbs energy or heat and transfers it to the surrounding material and thereby induces a local increase in temperature. A selective solidification is achievable thereby.

Suitable materials within the meaning of the invention are, for example, IR absorbers, in particular containing carbon black and/or graphite.

“Application device,” “application means” or “slip application device” or “closer” (101) within the meaning of the invention is any device by means of which the slip may be applied in a targeted and dosable manner, for the purpose of producing a material layer, which has a defined layer thickness. The “slip application device” may also be referred to as a recoater and is designed in such a way that a uniform material layer may be applied to the build plane or to the material layer applied in a preceding work step.

“Printing device” within the meaning of the invention is understood to be a means which is suitable for applying the binder material in a defined area on the material layer, in a predetermined quantity (volume) and at a defined time.

“Build plane” or “building platform” (e.g., 105) within the meaning of the invention is the build space as an area in which the slip is applied and the material layer is produced. The build space essentially has the same area as the build plane. The “build plane” may be part of a build container for carrying out the method in a batch process, or it may be inserted into and removed from the build container and is preferably adjustable in height. “Build plane” in a continuous method setup is the surface to which the slip is applied horizontally or preferably obliquely, i.e., at an angle of less than 90° in relation to the horizontal build plane.

“Energy application” within the meaning of the invention is the application of thermal or radiant energy during the method. In particular, it is the application of thermal or radiant energy to the build space as a whole or locally. “Locally” within the meaning of the invention means that an energy source, such as an IR emitter (401) or functionally equivalent devices (e.g., a combination of 400 and 401) are moved over the top material layer or are situated thereabove, and the temperature in the top material layer, preferably in the top and next lower material layer, is raised above the ambient temperature. The energy application causes the material layers, to which an energy-absorbing binder material was applied, to bind together, preferably to be sintered, and thereby to form the three-dimensional molded body according to the computer data (CAD data).

“Energy source” within the meaning of the invention is a device which emits energy, for example in the form of thermal radiation (401), or any other functionally equivalent device which performs this purpose and may therefore be used in the method according to the invention.

“Organized cooling” within the meaning of the invention is understood to be the fact that the molded body is cooled in a certain way during the method process or after the buildup of the material layers within a time frame which is matched to the materials used in such a way that the finished molded part has the best possible material properties, and the best possible work results are achieved with regard to material shrinkage and distortion as well as molded part accuracy. The molded part is preferably cooled slowly over a period of one or multiple hours with the aid of suitable means, or is abruptly cooled in a single step.

Preferred aspects of the invention are explained in greater detail below.

In one preferred aspect, the invention relates to a method for producing three-dimensional molded parts in a device, the method including the following steps in a possibly temperature-regulated build space (also see FIG. 1):
a. Producing a material layer by applying slip to a build plane (preferably a building platform), possibly in a build space, with the aid of an application means, in a predetermined layer thickness;
b. Applying a liquid binder material to selected areas of the material layer;
c. Applying energy;
d. Lowering the build plane by a desired layer thickness or raising the application means and possibly additional device means by a desired layer thickness;
e. Repeating steps a.) through d), the binder material containing or comprising an energy-absorbing material;
f. Removing the material surrounding the molded parts to obtain the molded parts.

The method according to the invention is characterized by a large number of advantages and positive effects. For example, a good and firm packing of the material layer may be achieved by using a slip, in particular of particulate material in a dispersion, during the application and for the purpose of creating a material layer. In addition, the finest particulate materials may surprisingly be used with the method according to the invention, which were not usable in other known 3D printing methods. In a first stage of the method, a solid powder cake of particle cake may advantageously be achieved using the method according to the invention. The method according to the invention thus achieves a stable positioning and placement of the particles in the applied layers. A particle displacement is thus prevented, which has a positive effect on the construction accuracy.

In one preferred specific embodiment of the method according to the invention, the slip includes a carrier fluid (200) and particulate material (201, 202). It may preferably be possible to at least partially melt on the particulate material.

The process conditions are preferably selected in such a way that the molded part results by means of at least partial, selective melting-on (203, 204) of the material during the process.

According to the invention, any carrier fluid (200) which is compatible with the other components may be used in the slip, and it is preferably selected from the group comprising water or an organic solvent, preferably an alcohol. The particulate material is preferably a sinterable material (202, 203), and it is preferably selected from the group comprising a thermoplastic, a polycondensate, preferably a polyamide (PA), metallic and/or ceramic particles or a mixture thereof. The carrier fluid (200) is preferably selected in such a way that the particulate material (202, 203) does not dissolve therein.

Energy-absorbing materials are known to those skilled in the art, who will select compatible energy-absorbing materials for the method and with regard to the remaining components. The energy-absorbing material preferably contains graphite or carbon black.

The method may be carried out in common 3D printing devices, which preferably have modifications, such as a mixer (300) for the slip. The slip is applied using common means suitable for this material, the slip preferably being applied using a coater device (101).

The layer thickness of the material layer may be set using different device mechanisms. For example the coater unit (101) and means connected thereto may be moved upward by the corresponding layer thickness. Another option is to lower the build plane (105). It is also possible to use a build container, within which the build plane (105) is movable. The predetermined height of the material layer is preferably set by the distance of the coater device (101) from the build plane. If a continuous method is used, for example by applying the material layer at an angle to the build plane, the layer thickness results from the feeding action during the process operation.

The build space or the surroundings of the coater (101) may be temperature-regulated and set and held at a temperature which is advantageous for the method. For this purpose, the temperature may be regulated with the aid of means outside or inside the build space (400, 401) or in the area around the layer application location, the build space preferably being heated or irradiated with IR (401).

The temperature is selected and set according to the particulate materials and the carrier fluid used. The build space or the ambient temperature is preferably regulated to a temperature of 40° C. to 200° C., preferably to 150° C. to 190° C., more preferably to 160° C. to 170° C.

To sinter, or at least to partially melt (203, 204) the molded part after selectively applying the energy-absorbing binder material, the energy is applied after every material layering step, after every second or every third to twelfth material layering step.

Any suitable means may be used to apply the energy. The energy is preferably applied in the form of electromagnetic energy (401), with the aid of a radiant heater in the IR-A and/or IR-B range or with the aid of an IR emitter.

The method conditions are selected and set in such a way that the temperature in the material layer, preferably in the final material layer, is brought to 190° C. to 210° C., preferably to 200° C.

After the buildup of the molded part (102) is completed, the molded part is embedded in the particulate material and cooled. Finally, the molded part (102) is separated from the unsolidified material (502), i.e., unpacked. This is done in such a way that the manufactured molded part is not damaged. The molded part is preferably unpacked in a liquid bath by the addition or spraying (500, 501) of the material block (502) with an aqueous liquid (501) or by means of another suitable procedure. Similarly to the carrier fluid for producing the slip, the aqueous liquid should be selected in such a way that the particulate material does not dissolve therein.

The binder material is selectively applied with the aid of device means known to those skilled in the art, preferably with the aid of a printing device (100), which preferably has computer-controlled nozzles.

Commercial slips may be used, or the slips may be mixed together individually. The slip is advantageously provided in a container, which has a stirring device (300) or a shaking device, so that the slip is a uniform dispersion, and a uniform application of material is thus ensured. The slip is preferably mixed together from particulate material and a carrier fluid shortly before it is applied.

After the slip is applied, a material layer having a predetermined layer thickness results. This is advantageously achieved by the removal, preferably evaporation, of the carrier fluid, preferably in less than 90 seconds per material layer, preferably 40 to 90 seconds, preferably 60 to 80 seconds. After removing the carrier fluid, the layer includes voids 205 between particles. Preferably the concentration of voids is less than 50%, such as illustrated in FIG. 2, part c.

As discussed, different particulate materials may be used, which may have different particle diameters. A particulate material having an average diameter of 1 to 250 μm, preferably 10 to 150 μm, more preferably 30 to 80 μm, is preferably used.

The layer thickness may be set individually and be varied even during the build process. The layer thickness of the material layer is preferably 1 to 500 μm, preferably 30 to 300 μm, more preferably 50 to 150 μm.

The binder material is dosed accordingly and advantageously depending on the layer thickness and material composition. The proportion of the binder material is preferably less than 20 vol. %, preferably less than 10 vol. %, more preferably less than 5 vol. %, even more preferably less than 2 vol. % with respect to the total volume of the molded part.

The material thickness after removal of the carrier fluid is preferably approximately 50% to 80% of the solid density of the particulate material.

After the molded part is unpacked, the molded part may be subjected to additional treatment steps. The additional method steps are preferably selected from a heat treatment and sintering.

The method according to the invention may be carried out with the aid of a removable build container in a batch process or in a continuous process. The 3D printing device will have corresponding device features which are known to those skilled in the art.

The slip is preferably applied horizontally (see FIG. 1) or, in one preferred specific embodiment, at an angle of less than 90° to the horizontal build plane (inclined printing). The method according to the invention is particularly suitable for inclined printing and preferably in combination with continuous method implementation, since an inclined printing process has particular requirements for the displacement resistance of the material layers. The special requirements are particularly advantageously met with the aid of the method according to the invention.

In another aspect, the invention is directed to a device for producing three-dimensional molded parts using a method according to the invention, as described above.

Likewise, one aspect of the invention relates to molded parts (102) produced according to a method according to the invention.

Another advantage of the method according to the invention is that materials may be used and molded parts may be produced which were previously unable to be produced in this manner. In particular, one advantage of using very fine particulate materials is that a very dense packing of the layers may be advantageously achieved. This has advantages with regard to the strength of the structural body itself or the green body itself obtained even before the selective solidification step. The shrinkage during sintering is furthermore reduced thereby, and the molded body accuracy is thus improved, compared to the CAD data. With the aid of the method according to the invention, in particular, less shrinkage is achieved than in the case of known methods and, as a result, distortion and warping of the component are greatly reduced or even avoided altogether, and the component quality is thus noticeably increased.

It is also advantageous that high spatial resolutions may be achieved, due to the very fine particulate materials which may be used. This may be used at a finer print resolution as well as by means of a thinner material thickness. The components thus produced have higher surface qualities than do comparable parts according to the prior art.

In another preferred specific embodiment, the build plane is temperature-regulated, so that the carrier fluid is quickly removed from the slip and a more stable body (102) results. Additional carrier fluid (200) is preferably removed from the applied slip by means of additional thermal energy, whereby the powder cake becomes even more stable. This may be achieved, for example, by using IR irradiation (401).

In a second process step, the IR irradiation (401) causes the areas printed with the binder material to melt or be sintered and form a molded body, which may be easily unpacked. This molded body may then be subjected to additional method steps in preferred specific embodiments.

Within the meaning of the invention, the individual features of the invention, or those described in combination, may be combined all together or in any possible combination, and selected individually, thereby resulting in a large number of preferred specific embodiments. Features which are illustrated individually are not to be understood as isolated, preferred specific embodiments of the invention but rather, within the meaning of the invention, may all be combined with each other in any manner, unless this is prevented for reasons of executability.

### BRIEF DESCRIPTION OF THE FIGURES:

FIG. 1: shows a diagram of a method sequence according to the invention;

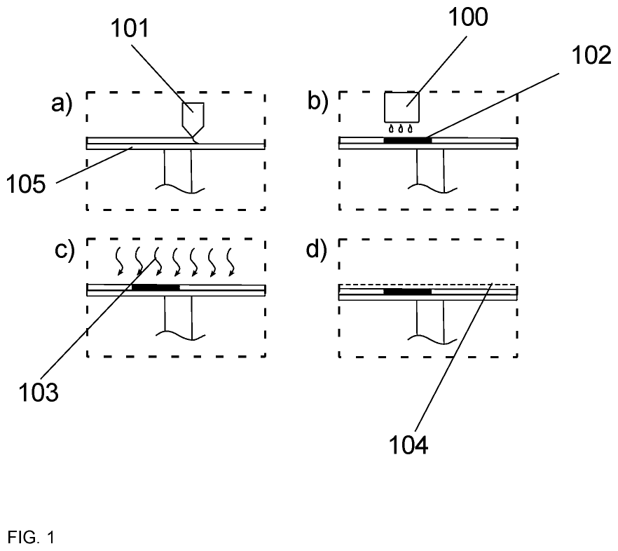

FIG. 2: shows an illustration of the compression of the particulate feedstock during a method sequence according to the invention;

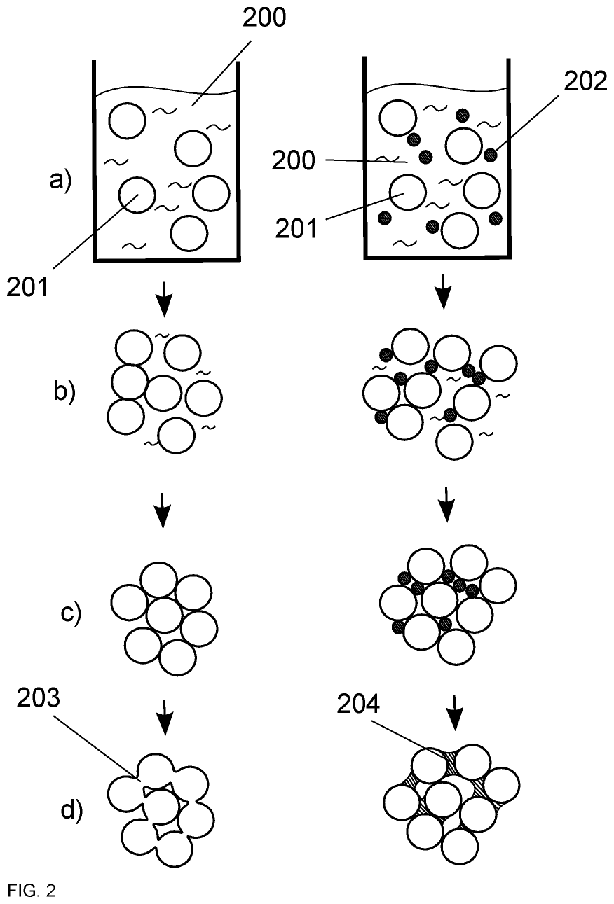

FIG. 3: shows a diagram of a device for carrying out the method according to the invention;

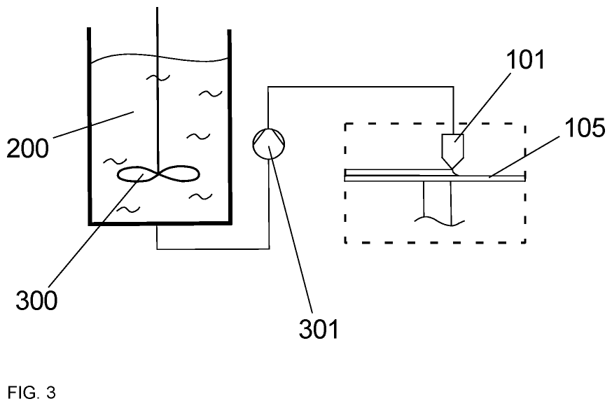

FIG. 4: shows devices for applying energy in the method according to the invention;

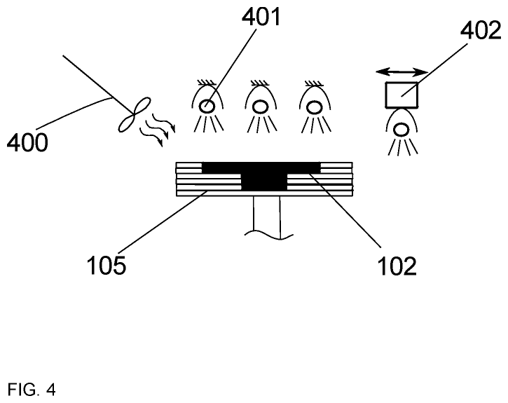

FIG. 5: shows an illustration of the removal of a component.

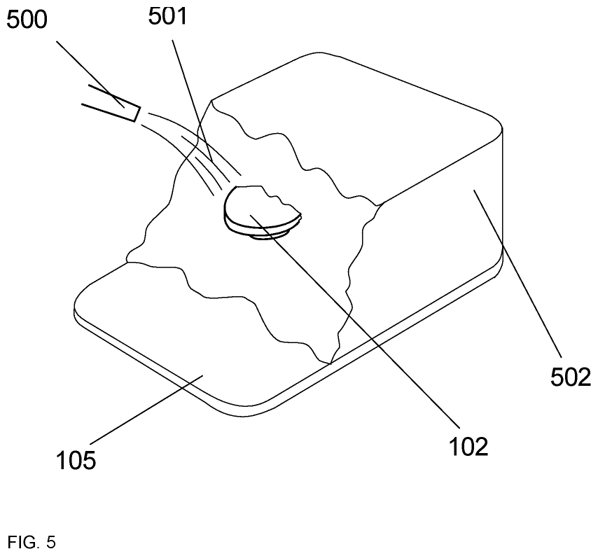

### REFERENCE NUMERALS

100 Print head

101 Slip application unit

102 Component

103 Energy

104 Lowered layer

105 Building platform

200 Dispersion medium

201 Sinterable and unsinterable particles

202 Binder particles

203 Sintering bridges

204 Adhesive bridges

300 Stirrer

301 Pump

400 Fan

401 Radiation source

402 Positioning unit

500 Rinsing nozzle

501 Solvent jet

502 Particulate material cake

1. A method for producing three-dimensional molded parts in a device, comprising the following steps:
a. producing a material layer by applying a slurry with an application means onto a contruction plane in a predetermined layer thickness, the slurry comprising a carrier fluid and particulate material, wherein the particulate material is or comprises an at least partially fusible material, wherein the particulate material is a sinterable material and is selected from the group consisting of a thermoplastic, a polyconsensate, preferably a polyamide (PA), metallic and/or ceramic particles or a mixture thereof;
b. applying a liquid binder material to selected areas of the material layer;
c. inputting energy for sintering or at least partial fusion, wherein the energy takes place in the form of electromagnetic energy, by means of a radiator in the IR-A or/and IR-B range or by means of an IR radiator or by means of a laser,
d. lowering the construction plane by a desired layer thickness or raising the application means and, if necessary, other means of the device by a desired layer thickness;
e. repeating steps a.) through d);
wherein the binder material contains or consists of an energy-absorbing material, said energy-absorbing material containing graphite or carbon black, and absorbs and releases energy and heat to the surrounding material, thereby causing a local temperature increase;
f. removing the material surrounding the molded parts to obtain the molded parts.

2. The method of claim 1, wherein the construction plane is arranged in a construction space.

3. The method of claim 1, wherein the process conditions are selected such that the molded part is formed by at least partially selectively fusing the fusible material in the slurry in the process.

4. The method of claim 1, wherein the carrier fluid is selected from the group consisting of water and an organic solvent.

5. The method of claim 1, wherein the application means is a coating device, optionally wherein the desired layer thickness of the material layer remains constant for each slurry application.

6. The method of claim 1, wherein a temperature of the construction platform or/and the construction space is adjusted, optionally the temperature adjustment is carried out with means outside or inside the build space, optionally the construction platform being heated or irradiated with IR.

7. The method of claim 1, wherein the temperature of the construction platform or/and the construction space is adjusted to a temperature of 40° C. to 200° C.

8. The method of claim 1, wherein the temperature of the construction platform or/and the construction space is adjusted to a temperature of 150° C. to 190° C.

9. The method of claim 1, wherein the temperature in the last material layer is adjusted to 190° C. to 210° C.

10. The method of claim 1, wherein the molded part is unpacked in a liquid bath, by adding an aqueous liquid to a material block including the molded part, or by spraying it off with an aqueous liquid.

11. The method of claim 1, wherein the binder material is applied by a printing device.

12. The method of claim 1, wherein the slurry is mixed together from the particulate material and the carrier fluid, shortly before application.

13. The method of claim 1, the material layer results from the removal of the carrier fluid, optionally be evaporation, optionally less than 90 seconds per material layer.

14. The method of claim 1, wherein the particulate material has an average diameter of 1 to 250 μm.

15. The method of claim 1, wherein the layer thickness of the material layer is 1 to 500 μm.

16. The method of claim 1, wherein the proportion of the binder material is preferably less than 20 volume percent.

17. The method of claim 1, wherein the particle layer, after the liquid is removed, is about 50% to 80% of the solid density of the particulate material.

18. The method of claim 1, wherein the further process steps are selected from heat treatment and sintering.

19. The method of claim 1, wherein the method is carried out in an exchangeable construction container in a batch process or in a continuous process.

20. The method of claim 1, wherein the slurry is applied horizontally or at an angle of less than 90° to the horizontal construction platform.
